(19) United States
(12) Patent Application Publication
(10) Pub. No.: US 2009/0180080 A1
(43) Pub. Date: Jul. 16, 2009

(54) Intra-Scene Dynamic Range Increase by Use of Programmed Multi-Step Filter

(76) Inventor: William S. Oakley, San Jose, CA (US)

Correspondence Address: TIPS GROUP;c/o Intellevate LLC, P. O. BOX 52050, Minneapolis, MN, 55402, US

(21) Appl. No.: 12/015,503

(22) Filed: Jan. 16, 2008

(51) Int. Cl. G03B 21/20

(52) U.S. Cl. 353/34; 353/121

(57) ABSTRACT

In one embodiment, a system is provided. The system includes a housing. The system also includes a light source coupled to the housing. The system further includes a light transmission modulating element coupled to the housing and arranged to receive light from the light source. The system also includes an image modulating subsystem arranged to receive light form the light transmission modulating element and coupled to the housing. The system further includes Output focusing optics arranged to receive light from the image modulating subsystem and coupled to the housing.

### BACKGROUND

Projection of motion pictures in theatres is still primarily done based on film and projection technology little changed since the dawn of motion pictures. However, compared to film, digital media allows for much easier storage of representations of an image. In order to move beyond film-based projection, it would be useful to provide a digital projector which fits general theater requirements.

Furthermore, a consortium of studios has set forth a standard for future digital projection systems. While this standard is by no means final, it provides a rough guide as to what a system must do—what specifications must be met. Thus, it may be useful to provide a digital projection system which meets the standards of the studio consortium.

### BRIEF DESCRIPTION OF THE DRAWINGS

The present invention is illustrated by way of example in the accompanying drawings. The drawings should be understood as illustrative rather than limiting.

FIG. 1 illustrates an embodiment of multiple position filter wheels which may be used with a projector.

FIG. 2 illustrates a timeline of operation of an embodiment of a projector with increased dynamic range provided through use of a multiple position filter.

FIG. 3 illustrates an embodiment of an LCoS image projector.

FIG. 4 illustrates an embodiment of a PLZT ceramic filter.

FIG. 5 illustrates an embodiment of an optical subsystem using two PLZT filters in parallel.

FIG. 6 illustrates an embodiment of a process of projecting images through use of a filter for increased dynamic range.

FIG. 7 illustrates an embodiment of a system using a computer and a projector.

FIG. 8 illustrates an embodiment of a computer which may be used with the projectors of FIGS. 3 (and 7), for example.

### DETAILED DESCRIPTION

A system, method and apparatus is provided for intra-scene dynamic range increase through use of a programmable multi-step filter. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In most optical projectors the dynamic range of the projected image is limited by two light levels, one is the brightest level achievable and the other is the lowest level achievable. While the highest level is usually set by the projection lamp power and system transmission, the lowest level is set by several factors, each of which adds light to the dark screen. When a dark screen is projected one contribution is the ambient light level in the theater which is not related to the projector performance. Another is the amount of light placed on the screen by the projector from two sources, the first being the light transmitted as part of the image and the second is the light scattered by the projection optics into the projection lens.

Both of these are determined as set factors of the light intensity input to the system. For example if the darkest elements of the image generator produce a contrast of 1000:1, (or 30 db, 3.0 density), and the scattered light level is also 1 part per thousand, the darkest part of the projected image will be at 2 parts per thousand, or a contrast of 500:1 in a totally dark cinema, i.e. no ambient light. In normal operation theater safety consideration require some ambient lighting, which will further reduce the image contrast seen by the viewer.

To achieve a large range of brightness on the projected image one may consider that the viewer is not specifically interested in the brightness level, but only the ability to discern scene details at all levels of brightness. Thus when a dark scene is shown, say 100 times less bright than full light, if the contrast dynamic range is only 500:1 the projected image can have no more contrast than 5:1, causing a low contrast image of ‘washed out’ appearance, regardless of the higher contrast in the scene at the image generator.

Hence the dynamic range of the visual experience can be greatly enhanced in a digital projector if the lamp brightness can be reduced when less bright scenes are shown, without causing a reduction in projected image contrast. However it is not necessary to maintain the full dynamic range in lower light level scenes as the human eye performs less well under these circumstances. It is desirable that when a prolonged dark scene is projected that the effective projector lamp brightness be reduced and the digital image be brightened to partially compensate. For example, in the above circumstance where a projected image of 500:1 contrast was reduced to 5:1, had the lamp level been reduced by 10:1 and the transmission at the image generation chip been increased by 10:1, the same screen brightness would be achieved but the contrast would increase to 50:1. Similarly a 50:1 reduction in lamp brightness and corresponding increase in image transmission would give the same screen brightness but an image contrast of 250:1.

It is therefore advantageous to provide a mechanism to effectively reduce the lamp brightness on demand without it being necessary to turn down the lamp power, which can cause instabilities and offers only a limited range of brightness. One means of doing this is to install a rotary filter wheel in the optical path near the input to the projector and which contains sections of different transmission. A filter wheel with different transmission zones, one being an open aperture, can be quickly rotated into any of several positions to effectively reduce the lamp power and increase the system optical dynamic range.

In a digitally driven display it is easy to preview the memory and determine which scenes do not exceed certain brightness levels and for how long this condition persists. For example if no area of a scene reaches to within a factor of eight (3 bits) of the maximum brightness for a period exceeding, for example, 1 second and extending for 45 seconds, then a filter reducing the light throughput can be rotated into the optical path for this duration and the display transmission increased by 3 bits on every pixel during the 45 second interval. During the time in question, each frame is displayed with brightness multiplied by a factor of 8 (3 bits) to compensate for the filter, thus maintaining the level of contrast of the projected image.

This effectively increases the projected scene contrast by the factor of eight (3 bits). A filter having several zones of, for example, 0 (open), 4 and 8 bits will effectively increase the projected inter scene contrast by up to 8 bits or 256, so that a projector with an inter scene dynamic range of say 10 bits (1,024:1) could project scenes over a brightness range of 256×1,000, i.e. 256,000:1 or 18 bits, with a minimum contrast of 1,000 in every scene. In effect the image generator inter scene dynamic range of 1000:1 can be moved down scale by a factor of 256 for different scenes without losing any contrast. The lower usable light level on the display screen is set not by the projected image contrast but the contrast on the screen set by the ambient light level in the theater.

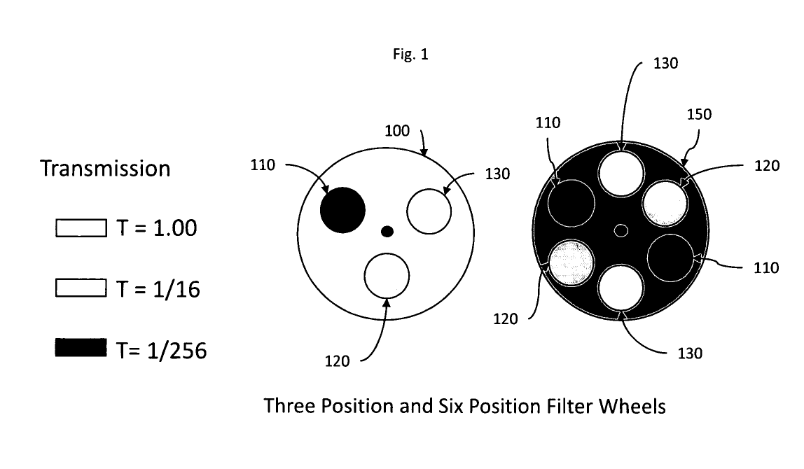

Pre-selection of filter wheel positions for each reduced brightness scene can be programmed into the projector digital controls so the filter position-scene registration is automatic. Only a few filter steps are necessary in many embodiments. Three filter positions are sufficient in some embodiments, and redundancy can be built into the filter locations, e.g. two positions of each step in a wheel as in FIG. 1. The wheel should step to a selected filter location in a bi-directional manner so sudden transition to very dark scenes or transition to bright scenes can quickly be accommodated, i.e. in less than one standard frame time of about 42 milliseconds.

In further reference to FIG. 1, two embodiments of potential filter wheels are illustrated, each of which may be used in various embodiments. Wheel 100 includes three distinct filters. Filter 110 is a relatively opaque filter, designed to transmit approximately 1/256^{th} of incident light. Filter 120 is a partially transmissive filter in this situation, designed to transmit approximately ⅛^{th} of incident light. Filter 130 is a fully transmissive filter in this situation, designed to transmit all incident light. In some embodiments, filter 130 may be provided by leaving the hole for the filter open.

An alternative six position wheel is presented as wheel 150. Each of filters 110, 120 and 130 is provided twice. Keeping the corresponding filters diametrically opposed in this instance allows for any position of the wheel to provide for an immediate change (one-position rotation) to either of the other two available filter settings. Additionally, unlike wheel 100, wheel 150 allows for a reduced step-size (60 degrees, rather than 120 degrees) when the wheel 150 is rotated.

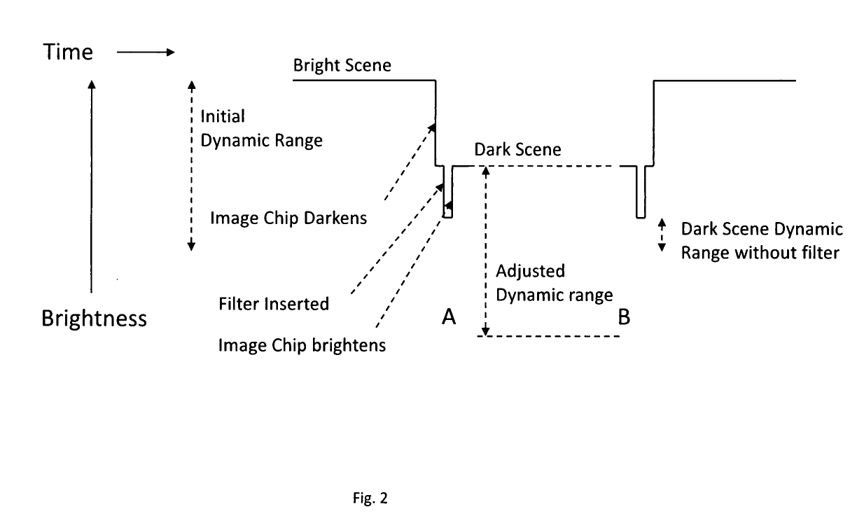

The filter configurations in FIG. 1 provide a single step response between any two optical transmission states. Bright flashes in the projected images are avoided by moving the wheel to the desired reduced transmission state immediately after the image moves to a darker state, and the image moved to a darker state immediately before the wheel moves to a higher transmission state. This timing sequence, with filter insertion at A and removal at B, is shown in FIG. 2.

The timing sequence of FIG. 2 allows for filter transitions at scene transitions, relying on quick mechanical and electrical transitions in the system. Initially, a bright scene is shown, with full transmission of light. When a transition to a dark scene occurs, the image chip for projection is darkened (adjusting to the new scene), the filter is switched, and the image chip is brightened (to account for the new filter in place). Projection with the filter in place can occur with the full dynamic range of the chip, and thus greater contrast on the screen. When the scene transitions to bright frames again, the filter is switched, and then the image chip is darkened, accounting for the return to greater light in the projector. Without the filter in place, the dynamic range on a dark scene is much lower, whereas with the filter in place, the dynamic range is expanded to allow for more variation.

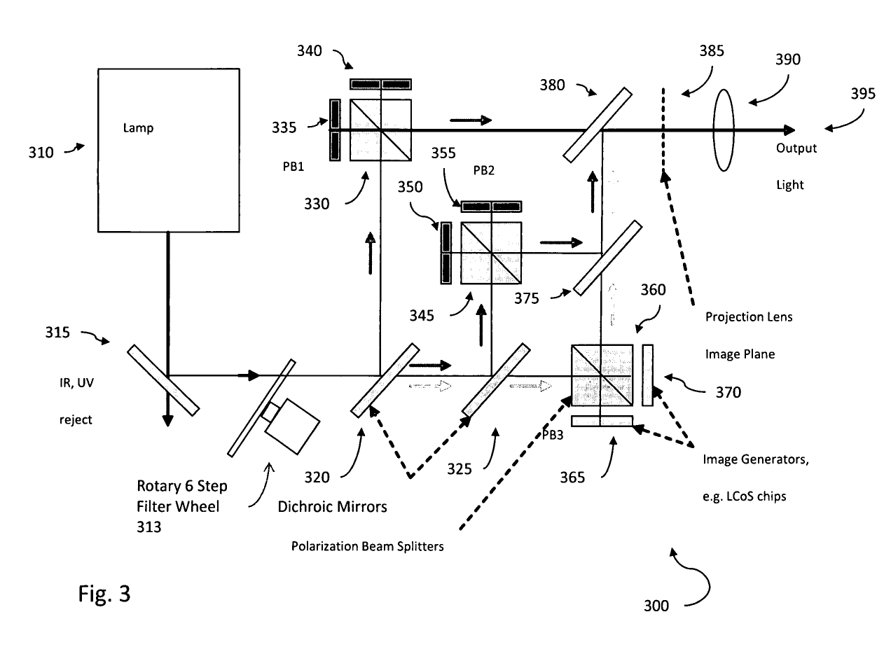

The rotary stepping transmission filter can be located in the optical path near the UV-IR reject filter, either just ahead or just behind as desired, depending on the filter material survivability under intense radiation. FIG. 3 shows a stepping filter wheel located in the optical path just after the UV-IR reject filter. Note that the filter wheel may be rotated out of plane relative to the other reflective surfaces as long as the excess light is removed from the optical path. Sideways deflection of the excess light to a dark absorber cooled by an external air flow is potentially desirable, thought not specifically illustrated to avoid added complexity in the drawings. This will also provide the shortest increase in the optical path. This option for dynamic range extension is applicable to all digital images and can be invoked at the projected display level without any additional requirement being placed on the original image capture.

Various projectors may be used with such a filter system. A high efficiency optical design for three color RGB (red, green, blue) image projectors is shown in FIG. 3 that uses six LCoS image planes to obtain both optical polarizations in all colors and is suitable for slide or dynamic video presentations to large screens. A randomly polarized white light source (310) is stripped of IR and UV components by an IR/UV rejection filter (315) and adjusted for contrast (light level) by filter wheel (313) to provide input to a first dichroic mirror (DM1-320) which reflects the blue portion of the spectrum to a polarizing beam splitter (PB1-330). The remainder of the spectrum passes through the dichroic mirror (320) to a second dichroic mirror (DM2-325), which reflects the red portion of the spectrum to a second polarizing beam splitter (PB2-345). The remaining spectrum passes to a third polarizing beam splitter (PB3-360).

Each of the three beam splitters separates its portion of the spectrum into two orthogonal polarization components, each of which is directed to an active LCoS (Liquid Crystal on Silicon) image generation plane (chips 335, 340, 350, 355, 365 and 370). Both polarization components are selectively polarization rotated on a pixel by pixel basis by an electrical signal applied to the LCoS display chips, so as to modulate the input light and impart an image onto the throughput light. Polarization modulated light is reflected from each LCoS chip back through the polarizing beam splitters (330, 345 and 360), so that both polarizations exit from the polarizing beam splitter and are re-combined with similarly processed light of the other spectral portions via dichroic mirrors (375 and 380) to form a white image (at projection lens image plane 385) which is focused on a remote screen using a projection lens (390) to provide output light 395.

Application of a voltage to an LCoS chip pixel that is insufficient for 90 degree rotation of the optical polarization results in a smaller rotation of the plane of polarization for a beam reflected from an LCoS chip. The partially rotated beam, on passing back through the polarizing beam splitter is split into two orthogonal polarized components of different intensities that exit the beam splitter in different directions. Thus the intensity of the output beam is reduced in proportion to the degree of polarization rotation (i.e. voltage on the pixel), and the unrotated portion is returned along its entrance path back toward the source.

The LCoS image generation devices employ a liquid crystal layer sandwiched between a transparent optical surface and a silicon electronic chip which applies a voltage to the liquid crystal layer on a pixel by pixel basis, causing spatially localized polarization rotation of light and thereby enabling an image to be imparted to light input through the transparent surface and reflecting back from the chip surface. The LCoS devices are universally employed in a reflective mode where the reflected light contains the image information.

Although many optical projection systems have been designed as multicolor displays using reflective LCoS image generation chips, one design the inventor is aware of is not well suited to large high brightness displays. The above referenced design uses four beam splitting cubes and several color absorption filters. It suffers from a low light efficiency as the input light is first split into two polarizations, each of which is then passed through color filters. This implementation causes half of the polarized light to be absorbed in the color filters. The absorbed light significantly heats the filters, trapping the heat between the polarizing cubes. Consequently this design, although compact, is only compatible with low intensity light, perhaps small fractions of a watt. A large screen multi-media display must be capable of transmitting several hundred watts of light, with potentially tens of watts absorbed in the image generating chips.

In contrast the proposed optical design implementation first separates the input light on a spectral basis, blue, red, then green light, using color separating dichroic mirrors, and each color is then input to its own polarizing beam splitter which directs polarized light to two LCoS image planes, one for each light polarization state. The light is thus spread over six separate LCoS chips. The reflected output images from the three beam splitters each contain both optical polarizations for their respective color, and the colored images are then re-combined using dichroic mirrors. By this means no light is absorbed in color filters and the system is capable of much higher optical power throughput as the dichroic mirrors absorb comparatively little light, and each color path is very efficient with minimal light loss at the LCoS planes. The LCoS image chips are accessible from the rear (the non-image side) and active chip cooling may therefore be employed to maintain each chip within a preferable operating temperature range.

In one embodiment, the blue light is first separated using a blue reflecting, red and green transmitting dichroic mirror. Blue light is separated first as, for a maximum brightness display, it can least tolerate optical power losses, and some red and green light is lost at the blue reflecting dichroic mirror. Next the red light is separated as this is less tolerant to loss than the green portion of the spectrum.

After passing through their respective LCoS image planes each color is recombined using dichroic mirrors similar to those used in the initial color separation process. It is noted the two re-combining dichroic mirrors are very angle sensitive as rotations will move the image planes out of registration. In an embodiment, the optical path lengths from the optical source to each LCoS image plane is essentially the same to enable essentially the same illumination fill factor and pattern to be obtained for each image plane. Similarly the three output colored images from the LCoS are all essentially equidistant from the projection lens, thereby enabling all images to be projected in focus.

The three images are typically combined in the image plane of the projection lens enabling existing projection lenses to be used. The images from the LCoS image generation chips are relayed to the projection lens image plane using standard relay lens techniques to maximize light throughput. The optical paths are arranged so that a single set of relay optics relays the image from each LCoS chip to the projector lens image plane. The relay optics is configured so the magnification from the LCoS image chips to the output image plane matches the output image plane format.

The basic optical system of FIG. 3 lies in a plane in some embodiments, which minimizes the number of optical elements, thereby minimizing scattered light and maintaining maximum image contrast. Each beam splitting cube is mounted on the same surface and all optical paths are co-planer. This facilitates fabrication and optical alignment. The co-planar layout also facilitates thermal control of the LCoS image generators as ‘through the support-plate’ airflow in a direction perpendicular to the plane of the optical system is easily configured and keeps the cooling air away from the optical path, reducing the possibility of optical artifacts created by air turbulence.

The LCoS image projector may use existing projection display components such as lamp hoses and associated power supplies, and available projection lenses. Both lamp houses and projection lenses are typically close to the image plane in film projectors. The light output from the lamp house is therefore relayed to the LCoS image chips by illumination relay optics with a magnification that matches the lamp output area to the image chip area.

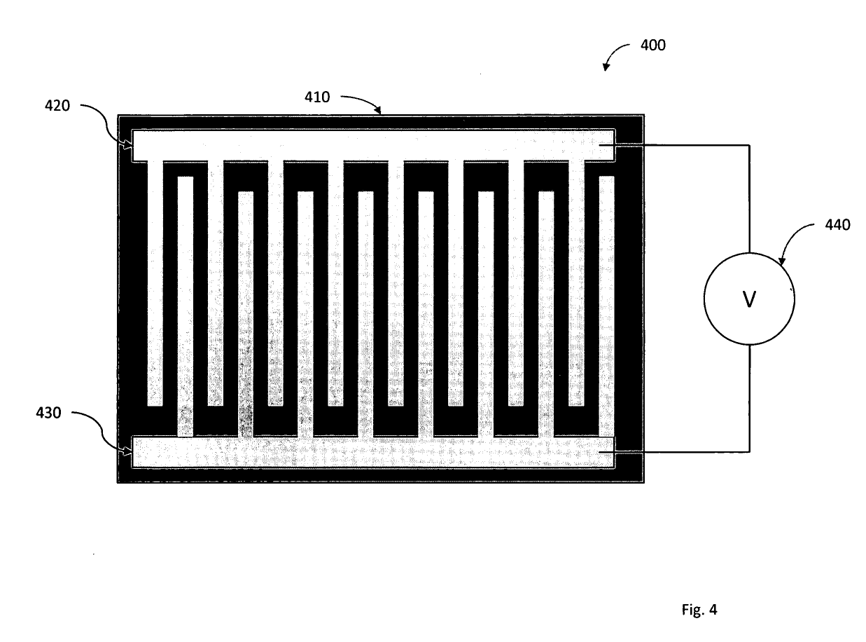

Generally it is desirable to minimize the number of moving parts in any system. One option for doing this in a projector is to replace the filter wheel with an electrically programmable filter that can withstand the high optical energy flux near the lamp source. This can be achieved by a filter made from PLZT ceramic, an electro-optic material that effectively rotates the plane of polarization of an optical beam to a degree set by an applied voltage. The PLZT ceramic wafer is coated with inter-digitated electrodes as shown in FIG. 4. The PLZT can have similar electrode patterns on both sides as the polarizing field propagates only a small distance into the material. A typical electrode material is a transparent layer of Tin Oxide, and the electrodes on the two sides are offset to provide relatively uniform transmission. Typical drive voltages are a few hundred volts and the response is limited by the device capacitance and is often about one millisecond.

With further reference to FIG. 4, one may further understand the structure and function of the PLZT. PLZT wafer system 400 is illustrated with PLZT wafer 410 having two electrodes 420 and 430, and an external voltage source 440. The electrodes 420 and 430 may constitute first and second electrodes, and each may be placed on opposite sides (first and second sides) of wafer 410. With a reasonable thickness of wafer 410, the electric field between electrodes 420 and 430 will sufficiently penetrate wafer 410 to change its transmission characteristics. For a material such as tin oxide, the interdigitated electrodes shown will generally suffice to provide a change in transmission characteristics throughout the wafer 410. The typical effect is a polarization rotation which in conjunction with a linear polarizer produces the effect of a filter with electrically controllable transmission. Edge effects can be avoided by over-sizing the wafer somewhat relative to the optical path for projection.

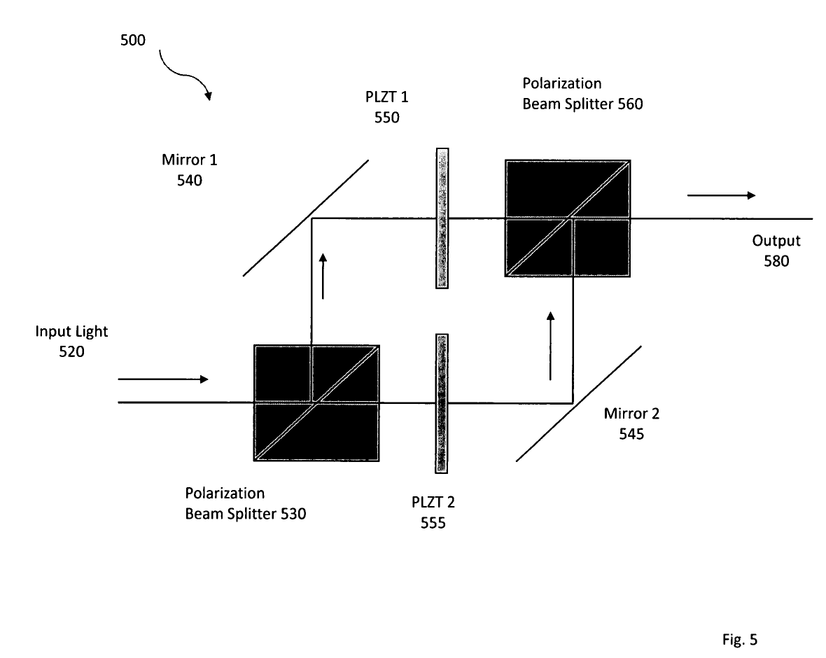

For maximum throughput light efficiency the lamp output must first be separated into two polarized components, each of which passes through a PLZT filter of settable transmission before the two components are recombined as in FIG. 5. The filter may be configured so the light transmitted is at a maximum, or minimum, or in the mid range, with no applied voltage, depending on the orientation of the electrodes relative to the beam splitters.

Further reference to FIG. 5 may illustrate the use of two parallel PLZT filters. System 500 provides an optical subsystem which may be used in a projector, for example. Input light 520 is first split by polarization beam splitter 530, resulting in two beams with orthogonal polarization. One such beam passes to mirror 540 and through PLZT filter 550. The other such beam passes through PLZT filter 555 and to mirror 545. Both beams are then recombined at polarization beam splitter 560 (undergoing a reverse transmission relative to the transmission through beam splitter 530). This results in output beam 560, which provides both polarizations of light at a reduced (potentially) intensity.

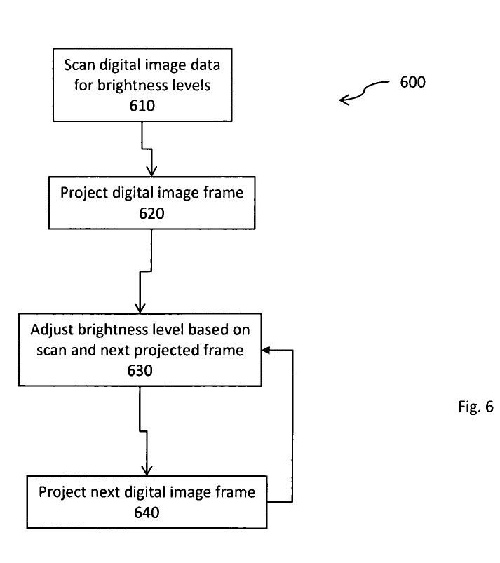

An overall process for use of a filter and projector to increase dynamic range in a projector is provided in FIG. 6. The process 600 includes scanning the image data for brightness levels (and storing such information), projecting a frame, adjusting brightness for the next frame, and then projecting the next frame. Process 600 and other processes of this document are implemented as a set of modules, which may be process modules or operations, software modules with associated functions or effects, hardware modules designed to fulfill the process operations, or some combination of the various types of modules, for example. The modules of process 600 and other processes described herein may be rearranged, such as in a parallel or serial fashion, and may be reordered, combined, or subdivided in various embodiments.

Process 600 initiates with a scan of available image data at module 610. The image data is scanned for brightness levels, and the levels are recorded, along with areas where a different brightness setting (e.g. a different filter or filter setting) may be used. In the case of differing filter voltages, this represents a voltage transition. In the case of different filter elements, this represents a filter transition (e.g. rotating in the proper filter). At module 620, the first image is projected. At module 630, a determination is made as to whether the filter needs to change for the next frame (based on the scan of digital data). The transition occurs as necessary. At module 640, the next frame is displayed. The process may then repeat modules 630 and 640 until the scanned data is completely projected, for example.

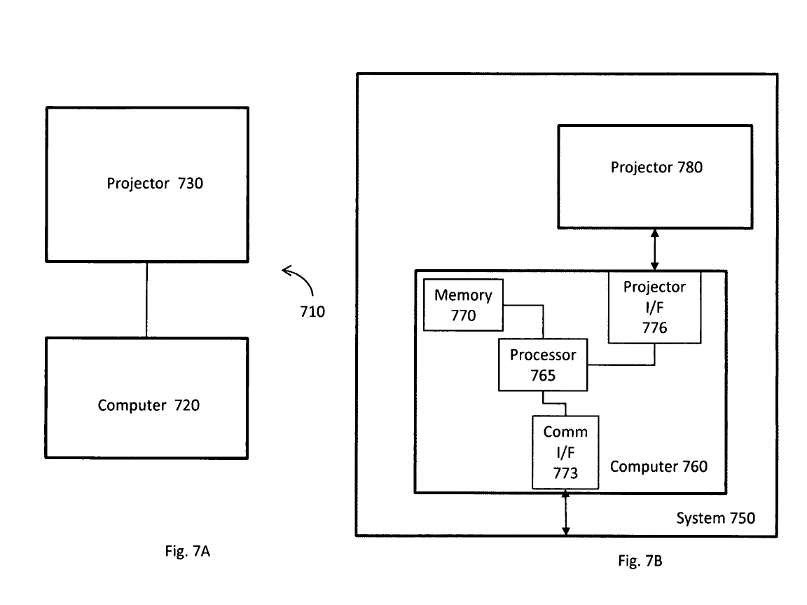

The overall system used with various implementations (of the methods and apparatuses described above) may also be instructive. FIG. 7A illustrates an embodiment of a system using a computer and a projector. System 710 includes a conventional computer 720 coupled to a digital projector 730. Thus, computer 720 can control projector 730, providing essentially instantaneous image data from memory in computer 720 to projector 730. Projector 730 can use the provided image data to determine which pixels of included LCoS display chips are used to project an image. Additionally, computer 720 may monitor conditions of projector 730, and may initiate active control to shut down an overheating component or to initiate startup commands for projector 730.

FIG. 7B illustrates another embodiment of a system using a computer and projector. System 750 includes computer subsystem 760 and optical subsystem 780 as an integrated system. Computer 760 is essentially a conventional computer with a processor 765, memory 770, an external communications interface 773 and a projector communications interface 776.

The external communications interface 773 may use a proprietary (a standard developed for such a device but not publicized by its developer), or a publicly available communications standard, and may be used to receive both digital image data and commands from a user. The projector communications interface 776 provides for communication with projector subsystem 780, allowing for control of LCoS chips (not shown) included in projector subsystem 780, for example. Thus, projector communications interface 776 may be implemented with cables coupled to LCoS chips, or with other communications technology (e.g. wires or traces on a printed circuit board) coupled to included LCoS chips. Other components of computer subsystem 760, such as dedicated user input and output modules, may be included, depending on the needs for functionality of a conventional computer system in system 750. System 750 may be used as an integrated, standalone system—thus allowing for the possibility that each theater may use its own projector with a built-in control system, for example.

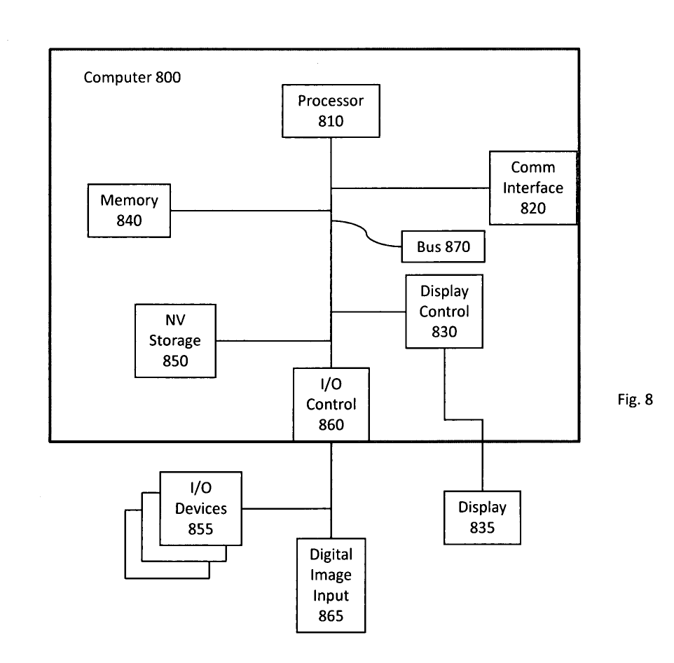

FIG. 8 illustrates an embodiment of a computer which may be used with the projectors of FIG. 3 (such as in the combinations of FIG. 7), for example. The following description of FIG. 8 is intended to provide an overview of computer hardware and other operating components suitable for performing the methods of the invention described above and hereafter, but is not intended to limit the applicable environments. Similarly, the computer hardware and other operating components may be suitable as part of the apparatuses and systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8 shows one example of a conventional computer system that can be used as a client computer system or a server computer system or as a web server system. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems. In the case of a closed network, a hardwired physical network may be preferred for added security.

The computer system 800 includes a processor 810, which can be a conventional microprocessor such as microprocessors available from Intel or Motorola. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). Display controller 830 can, in some embodiments, also control a projector such as those illustrated in FIGS. 1 and 5, for example. The input/output devices 855 can include a keyboard, disk drives, printers, a scanner, and other input and output devices, including a mouse or other pointing device. The input/output devices may also include a projector such as those in FIGS. 1 and 5, which may be addressed as an output device, rather than as a display. The display controller 830 and the I/O controller 860 can be implemented with conventional well known technology. A digital image input device 865 can be a digital camera which is coupled to an i/o controller 860 in order to allow images from the digital camera to be input into the computer system 800. Digital image data may be provided from other sources, such as portable media (e.g. FLASH drives or DVD media).

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

A further discussion of some potential embodiments may be useful. In one embodiment, a system is provided. The system includes a housing. The system also includes a light source coupled to the housing. The system further includes a light transmission modulating element coupled to the housing and arranged to receive light from the light source. The system also includes an image modulating subsystem arranged to receive light form the light transmission modulating element and coupled to the housing. The system further includes Output focusing optics arranged to receive light from the image modulating subsystem and coupled to the housing.

The light transmission modulating element may be a filter wheel having a plurality of positions of varying transmissivity. In one embodiment, the filter wheel is a six position filter wheel having three transmissivity levels, with each transmissivity level occupying two positions diametrically opposite a center of the filter wheel. In another embodiment, the filter wheel is a three position filter wheel having three transmissivity levels, one transmissivity level associated with each position. In yet another embodiment, the light transmission modulating element is a PLZT filter.

In some embodiments, the light transmission modulating element includes a first polarization beam splitter coupled to the housing and arranged to receive light from the light source. The light transmission modulating element also includes a first PLZT filter coupled to the housing and arranged to receive light of a first polarization from the first polarization beam splitter. The light transmission modulating element further includes a second PLZT filter coupled to the housing and arranged to receive light of a second polarization from the first polarization beam splitter. The light transmission modulating element also includes a second polarization beam splitter coupled to the housing and arranged to receive and combine light from the first PLZT filter and the second PLZT filter.

In yet another embodiment, the image modulating subsystem includes a first LCoS assembly coupled to the housing. The first LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The first LCoS assembly further includes a first heat sink mounted on the first LCoS chip and a second heat sink mounted on the second LCoS chip. Such an embodiment may further involve the image modulating subsystem further including a second LCoS assembly coupled to the housing. The second LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The second LCoS assembly further includes a first heat sink mounted on the first LCoS chip and a second heat sink mounted on the second LCoS chip. Similarly, the image modulating subsystem may further include a third LCoS assembly coupled to the housing. The third LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The third LCoS assembly further includes a first heat sink mounted on the first LCoS chip and a second heat sink mounted on the second LCoS chip.

In some embodiments, the system further includes an IR/UV rejection optical component disposed between the light source and the light transmission modulating element. In some embodiment, the system may also include a processor and a memory coupled to the processor. Likewise, the system may further include a bus coupled to the memory and the processor. Moreover, the system may further include a communications path between the processor and each of the first and second LCoS chips of the first, second and third LCoS assemblies.

In another embodiment, a method is provided. The method includes observing a light level of an image of a projector. The method also includes shifting a light transmissivity level of the projector. The method further includes projecting the image based on the light transmissivity level of the projector.

The method may further include observing a change in light level of the image of the projector. The method may also include shifting the light transmissivity level of the projector again. The method may additionally include projecting the image based on the light transmissivity level of the projector.

In some embodiments, observing the light level occurs as the image is projected. In some embodiments, observing the light level includes reviewing image data to be projected and recording light transmissivity level settings based on reviewing the image data to be projected. Observing the light level also includes determining a current light transmissivity level setting based on image data associated with the image of the projector. Shifting a light transmissivity level of the projector in such embodiments includes shifting the light transmissivity level of the projector to the current light transmissivity level setting.

In some embodiments, observing the light level includes determining a current light transmissivity level setting based on image data associated with the image of the projector. Shifting a light transmissivity level of the projector includes shifting the light transmissivity level of the projector to the current light transmissivity level setting. In some embodiments, the light transmissivity level may be set to one of three discrete settings associated with a mechanical component. In other embodiments, the light transmissivity level may be set with an electrical signal based on an electrical response associated with an electronically alterable optical component.

In yet another embodiment, a method is provided. The method includes reviewing image data to be projected. The method further includes recording light transmissivity level settings based on reviewing the image data to be projected. The method also includes determining a current light transmissivity level setting based on image data associated with an image of a projector. The method further includes shifting the light transmissivity level of the projector to the current light transmissivity level setting. The method also includes projecting the image based on the light transmissivity level of the projector. In some embodiments, the light transmissivity level may be set to a nearly continuously variable magnitude with an electrical signal based on an electrical response associated with an electronically alterable optical component. In other embodiments, the light transmissivity level may be set to one of a plurality of discrete settings associated with a mechanical component.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. A system comprising:
A housing;
A light source coupled to the housing;
A light transmission modulating element coupled to the housing and arranged to receive light from the light source;
An image modulating subsystem arranged to receive light form the light transmission modulating element and coupled to the housing; And
Output focusing optics arranged to receive light from the image modulating subsystem and coupled to the housing.

2. The system of claim 1, wherein:
The light transmission modulating element is a filter wheel having a plurality of positions of varying transmissivity.

3. The system of claim 2, wherein:
The filter wheel is a six position filter wheel having three transmissivity levels, with each transmissivity level occupying two positions diametrically opposite a center of the filter wheel.

4. The system of claim 2, wherein:
The filter wheel is a three position filter wheel having three transmissivity levels, one transmissivity level associated with each position.

5. The system of claim 1, wherein:
The light transmission modulating element is a PLZT filter.

6. The system of claim 1, wherein:
The light transmission modulating element includes
A first polarization beam splitter coupled to the housing and arranged to receive light from the light source;
A first PLZT filter coupled to the housing and arranged to receive light of a first polarization from the first polarization beam splitter;
A second PLZT filter coupled to the housing and arranged to receive light of a second polarization from the first polarization beam splitter; And
A second polarization beam splitter coupled to the housing and arranged to receive and combine light from the first PLZT filter and the second PLZT filter.

7. The system of claim 1, wherein:
The image modulating subsystem includes a first LCoS assembly coupled to the housing, the first LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the first LCoS assembly further includes a first heat sink mounted on the first LCoS chip and a second heat sink mounted on the second LCoS chip.

8. The system of claim 7, wherein:
The image modulating subsystem further includes a second LCoS assembly coupled to the housing, the second LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the second LCoS assembly further includes a first heat sink mounted on the first LCoS chip and a second heat sink mounted on the second LCoS chip; And
A third LCoS assembly coupled to the housing, the third LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the third LCoS assembly further includes a first heat sink mounted on the first LCoS chip and a second heat sink mounted on the second LCoS chip.

9. The system of claim 8, further comprising:
An IR/UV rejection optical component disposed between the light source and the light transmission modulating element.

10. The system of claim 9, further comprising:
A processor;
A memory coupled to the processor;
A bus coupled to the memory and the processor; And
A communications path between the processor and each of the first and second LCoS chips of the first, second and third LCoS assemblies.

11. A method, comprising:
Observing a light level of an image of a projector;
Shifting a light transmissivity level of the projector; And
Projecting the image based on the light transmissivity level of the projector.

12. The method of claim 11, further comprising:
Observing a change in light level of the image of the projector;
Shifting the light transmissivity level of the projector again; And
Projecting the image based on the light transmissivity level of the projector.

13. The method of claim 11, wherein:
Observing the light level occurs as the image is projected.

14. The method of claim 11, wherein:
Observing the light level includes:
Reviewing image data to be projected;
Recording light transmissivity level settings based on reviewing the image data to be projected; And
Determining a current light transmissivity level setting based on image data associated with the image of the projector;
And wherein:
Shifting a light transmissivity level of the projector includes shifting the light transmissivity level of the projector to the current light transmissivity level setting.

15. The method of claim 11, wherein:
Observing the light level includes:
Determining a current light transmissivity level setting based on image data associated with the image of the projector;
And wherein:
Shifting a light transmissivity level of the projector includes shifting the light transmissivity level of the projector to the current light transmissivity level setting.

16. The method of claim 14, wherein:
The light transmissivity level may be set to one of three discrete settings associated with a mechanical component.

17. The method of claim 14, wherein:
The light transmissivity level may be set with an electrical signal based on an electrical response associated with an electronically alterable optical component.

18. A method, comprising:
Reviewing image data to be projected;
Recording light transmissivity level settings based on reviewing the image data to be projected;
Determining a current light transmissivity level setting based on image data associated with an image of a projector;
Shifting the light transmissivity level of the projector to the current light transmissivity level setting; And
Projecting the image based on the light transmissivity level of the projector.

19. The method of claim 18, wherein:
The light transmissivity level may be set to a nearly continuously variable magnitude with an electrical signal based on an electrical response associated with an electronically alterable optical component.

20. The method of claim 18, wherein:
The light transmissivity level may be set to one of a plurality of discrete settings associated with a mechanical component.
